(19) United States
(12) Patent Application Publication
(10) Pub. No.: US 2026/0228242 A1
(43) Pub. Date: Aug. 6, 2026

(54) DYNAMIC GENERATION OF DATA LINEAGE

(71) Applicant: BMC Software, Inc., Houston, TX (US)

(72) Inventors: Jennifer Ann Glenski, Denver, CO (US); Eric Michael Anderson, Friendswood, TX (US); Devasia Antony Muthalakuzhy Thomas, San Jose, CA (US)

(21) Appl. No.: 19/043,210

(22) Filed: Jan. 31, 2025

(51) Int. Cl. G06F 16/28; G06F 16/22

(52) U.S. Cl. CPC G06F 16/288; G06F 16/2255

(57) ABSTRACT

Dynamic data lineage generation may be provided by determining a read hash tree representing read data and determining a write hash tree representing write data. By then performing a comparison of the read hash tree and the write hash tree, a data lineage relationship between the read data and the write data may be generated, based on the comparison.

### TECHNICAL FIELD

This description relates to data lineage in Information Technology (IT) environments.

### BACKGROUND

Data lineage in an IT environment generally refers to the process of tracking data from its source and through various transformations to its final destination(s). Data lineage provides a detailed, often visual, representation of the history of specific pieces of data. Data lineage may be used, for example, to ensure data quality, identify root causes of any data issues, understand an impact(s) of changes within an IT environment, and provide compliance with any regulatory requirements.

Unfortunately, it is difficult or impossible for conventional systems to provide data lineage in a complete and/or timely fashion, particularly for large or complex IT environments. For example, modern data environments typically involve multiple interconnected systems, from traditional databases to cloud data platforms, so that lineage paths within and among such systems are obscured by intricate webs of data flows.

Conventional techniques may rely on log records (e.g., Standard Query Language (SQL) logs) to reconstruct data lineage, including finding links between table names. Such log records thus provide discrete transactions that must be stitched together, often manually, which is a time-consuming and error-prone process. Moreover, the log records typically do not provide a comprehensive list of data transformations. For example, SQL log records may not provide non-SQL transactions, so that other types of transactions must be tracked using other techniques, including manual techniques.

Consequently, conventional data lineage techniques are ineffective, costly, and time-consuming. Resulting data lineage visualizations are often significantly out of date, include errors, and/or are incomplete. As a result, it is infeasible or impossible to use obtained data lineages for root cause analysis, impact analysis, or other intended or desired outcomes.

### SUMMARY

According to one general aspect, a computer program product may be tangibly embodied on a non-transitory computer-readable storage medium and may include instructions that, when executed by at least one computing device, are configured to cause the at least one computing device to determine a read hash tree representing read data and determine a write hash tree representing write data. The instructions, when executed by the at least one computing device, are configured to cause the at least one computing device to perform a comparison of the read hash tree and the write hash tree and generate a data lineage relationship between the read data and the write data, based on the comparison.

According to other general aspects, a computer-implemented method may perform the instructions of the computer program product. According to other general aspects, a system may include at least one memory, including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of system for dynamic generation of data lineage.

FIG. 2 is a flowchart illustrating example operations of the system of FIG. 1.

FIG. 3 is a block diagram illustrating an example implementation of the system of FIG. 1.

FIG. 4 is an example hash tree used in the systems of FIGS. 1-3.

FIG. 5 illustrates use of a graph database of FIGS. 1-3 to store multiple hash trees.

FIG. 6 illustrates an example comparison of multiple hash trees of FIGS. 4 and 5.

FIG. 7 is a flowchart illustrating example techniques for processing read requests using the techniques of FIGS. 1-6.

FIG. 8 is a flowchart illustrating example techniques for processing write requests and generating data lineages using the techniques of FIGS. 1-6.

### DETAILED DESCRIPTION

Described systems and techniques provide fast, reliable, configurable, and efficient data lineage generation for an organization or other entity, even when large quantities of data are frequently being accessed and modified across multiple types of storage contexts and/or within multiple data pipelines. Using described techniques, organizations may use dynamically generated data lineages to, for example, perform root cause analysis and impact analysis, ensure data quality and regulatory compliance, and otherwise increase a trust in, and validity of, organizations' data. Moreover, described techniques are capable of providing such data lineages in real time, without introducing any or appreciable latency into operations of underlying data processing operations.

As referenced above, in today's business environment, data regularly flows through organizations and between different departments and data stores to be used in different systems, applications, and business processes. This means data changes frequently have a ripple effect through multiple different systems in an organization, making it difficult to accurately identify the source of data used in business operations. Not knowing the data source means it is difficult to verify the freshness and validity of data, which lowers the trust users have in the data and related outcomes.

Data lineage may be used to help understand the impact of changes to data by presenting a view of potential upstream and downstream implications and/or effects. This reduces risk and costs for data management, including, e.g., reduced duplication of effort and faster time-to-resolution of data issues, as well as faster time-to-delivery for data products and outcomes.

Data lineage is also beneficial in training and using artificial intelligence (AI) and/or machine learning (ML) models. For example, data changing upstream may affect downstream AI or models using (e.g., being trained on) that data, because data changes may significantly impact the effectiveness of the model or even render the model useless.

Data lineage is also useful in maintaining data authenticity and confidentiality. For example, an ability to produce accurate and timely data lineage may prevent unintended disclosure of private or personal information of users.

Described techniques include tracking and storing of read operations (e.g., reading data from a data store) in conjunction with tracking write operations (e.g., writing data to the same or different data store). For example, a first data set may be read from a first data store, modified to obtain a second data set, and the second data set may be written to a second data store. When the first data set is read, a corresponding first hash tree may be generated for the first data set and stored. When the second data set is written, a corresponding second hash tree may be generated and compared against potentially matching hash trees, including the first hash tree. If a sufficiently close match is determined between the first hash tree and the second hash tree, then a data lineage transaction may be determined and associated with the combined read/write operations.

In described techniques, the first/second hash trees enable fast and accurate determination of a partial data match between the first data set that is read and the modified second data set that is written. Given that data lineage transactions frequently modify data, such partial data matching ability enables dynamic, real-time construction of a desired datal lineage, which, e.g., may then be visualized for users using a data lineage visualization service. Although the simplified example above references a general modification of the first data set prior to writing the second data set, it will be appreciated that such modifications may refer to, or include, any available data modification, including, e.g., joins, filters, or splits of data set(s).

In addition, data sets may be associated with various types of meta data, which further enable dynamic generation of data lineages. For example, transaction data of a data set may be separated from facilitation data of the data set. As described in detail below with additional examples, transaction data generally includes content of a data set that is related to (e.g., unique to) a read or write transaction. Such transaction data may be expressed independently of a given format or language (e.g., SQL vs non-SQL), while facilitation data refers to metadata that facilitates a transaction and that that is not necessarily unique to the transaction. Examples of such facilitation data may include, but are not limited to, protocol headers, message encodings, authentication data, and/or compression metadata. Other types of metadata may exist with respect to a given transaction, as well, including, e.g., network address information such as Internet Protocol (IP) address data, such as inclusion of a given IP address within a defined TP zone.

By using informational content of datasets, as compared, for example, to formatting data, system-specific data, or other metadata that facilitates use of the information data by one or more storage systems. Described techniques may thus be used to construct the types of hash-based data representations referenced above, while omitting associated metadata. As a result, a quantity of required data processing is reduced, and described techniques are applicable across many different types of storage systems. For example, such metadata may be different for a Standard Query Language (SQL) database than for a File Transfer Protocol (FTP) database, or for a storage system using the Windows operating system (OS) as compared to a storage system using the Linux OS.

Thus, by separating the transaction data or content of a read/write transaction, described techniques enable the types of partial or complete data matches referenced above, independently of a data format or language being used. For example, referenced hash trees may be constructed based on the data/content itself, so that subsequent hash tree searching/matching operations may be conducted based on the data/content itself. This approach enables searching/matching across different data types, while using reduced data volumes (e.g., since the metadata is not required to be hashed/compared in the same way(s) as the data content).

Nonetheless, the metadata may be used to further facilitate an accuracy, completeness, and/or relevance of data lineage transactions, as well as of a data lineage as a whole. For example, metadata timestamps may enable or facilitate searching and/or matching operations, e.g., by restricting a search space of potential hash tree matches and may also facilitate determination of a direction of matched data (e.g., a source/target data store(s)) and/or of a manner in which the data was transformed.

Additionally, the metadata may be useful in filtering data/transactions to ensure that a generated data lineage includes data lineage transactions that are relevant or useful, without including data that does not further the various discussed purposes of the generated data lineage. For example, a data pipeline generally refers to a series of jobs or tasks that together provide a defined workflow intended to provide a desired result. In many cases, the jobs and/or tasks are performed by automated agents configured to process specified data to produce a corresponding data processing result.

Even if such data pipelines are well-defined and stable, which is not always the case, it is often not feasible to track data directly through the use of data pipelines. For example, organizations often use many different data pipelines that overlap in time as well as in data and/or data stores being used. Each data pipeline may include many different jobs and/or tasks, and multiple instances of a single data pipeline may be executing at a given point in time. In addition, the same data stores used in the various data pipelines may be simultaneously used for other reasons (e.g., ad hoc reasons) by members of a relevant organization.

Although it may be difficult to provide comprehensive, timely, and accurate tracking of data pipelines for at least the reasons referenced above, such data pipelines, by their nature, include relevant and useful information for operations of an organization, and for desired data lineages. Therefore, collected metadata may be used to help ensure that corresponding transaction data (e.g., content) is likely to be relevant to one or more data pipelines, or otherwise relevant for inclusion in data lineage generation. For example, the IP zoning techniques referenced above, and described in more detail, below, may be used to identify read or write transactions associated with an IP zone(s) and likely to be related to a desired data lineage. Consequently, non-relevant transaction data may be omitted from use in hash tree generation and/or searching, thereby conserving associated resources.

In example implementations, described techniques may identify data lineage transactions and provide a corresponding data lineage in a dynamic, real-time fashion, without blocking or slowing other jobs and/or tasks processing the same underlying data. For example, a job being processed as part of a data pipeline may have associated data identified and copied to a separate processing space (e.g., a user space), so that the original job may continue uninterrupted with its assigned data processing.

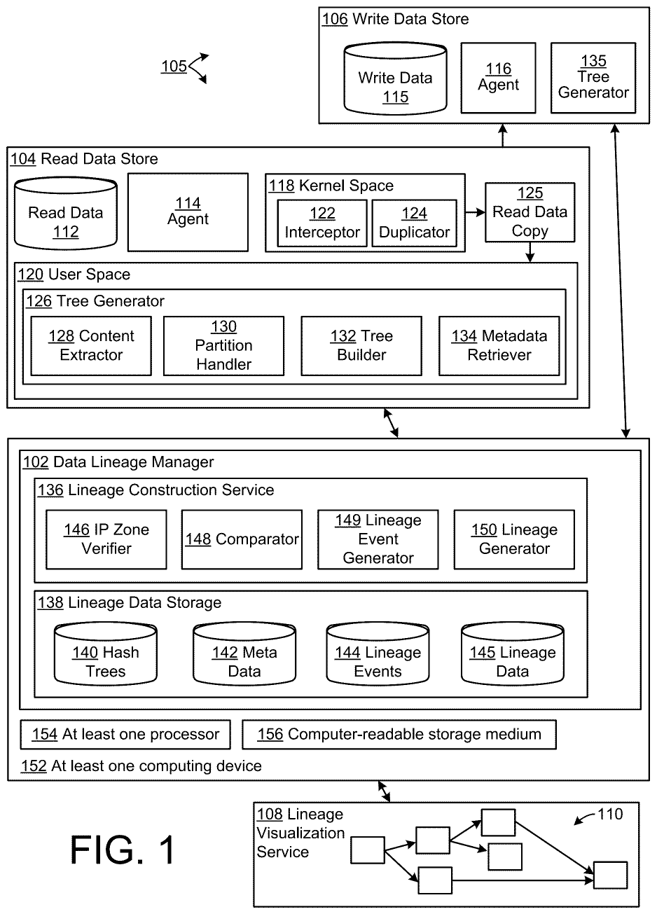

FIG. 1 is a block diagram of system for dynamic generation of data lineage. In the example of FIG. 1, a data lineage manager 102 is configured to interact with multiple data stores, represented by a read data store 104 and a write data store 106 within a technology landscape 105, to enable a lineage visualization service 108 to provide a data lineage visualization 110. As described above, even though the read data store 104 and the write data store 106 may represent many different data stores actively executing many different read/write transactions within the technology landscape, the data lineage manager 102 provides automatic, dynamic, and/or real-time generation of the data lineage visualization 110. Accordingly, users of the data lineage manager 102 may be provided with the various benefits of data lineage construction referenced above, including, e.g., root cause analysis, impact analysis, data verification, and data quality.

In the example of FIG. 1, the technology landscape 105 may refer to virtually any network environment in which the data lineage manager 102 may be implemented. For example, the technology landscape 105 may represent, or include, a private or local area network of an enterprise, or an application(s) and other resources that are securely provided over the public internet or other network. In the example of FIG. 1, it is assumed that the data lineage manager 102, the read data store 104, the write data store 106, and the technology landscape 105 are all associated with, e.g., part of, an organization or other entity, which is itself subject to some type or extent of centralized control or governance. For example, such an organization may include a corporation or group of corporations, or a government, academic, or non-profit entity.

The read data store 104 and the write data store 106 thus should be understood to broadly represent any data store(s) that might be found within such environments. Such data stores may implement many different platforms, operating systems, applications, databases, database management systems, and various other hardware and software associated with storing corresponding types of data. Various ones of such data stores may thus be associated with different types of formatting, communications protocols, interfaces, programming languages, and other types of metadata. More specific examples of such data stores are provided below or would be apparent. Although described in FIG. 1 with respect to read and write terminology for ease of explanation, it will be appreciated that any given data store within described environments may serve as either a read data store and/or a write data store.

The data lineage manager 102 may be configured within the technology landscape 105 to be accessible by all data stores for which relevant data lineage events may occur. For example, such data stores may be part of, or may participate in, at least one data pipeline.

In FIG. 1, read data 112 represents data read by an agent 114, e.g., as part of at least one data pipeline. In the example of FIG. 1, the agent 114 may represent, e.g., an application or service configured to pass a data set that has been read from the read data 112 to an agent 116 of the write data store 106. The agent 116 may then modify the received data set and write the resulting, modified data set to a specified database, represented in FIG. 1 as write data 115.

Of course, FIG. 1 illustrates a highly simplified example, provided for the sake of explanation. In various example implementations, the technology landscape 105 may include many different physical or virtual data stores, each of which may be involved in the execution of many different read and/or write transactions within a given timeframe.

For example, the agents 114, 116 may be participating in one or more data pipelines, and may thus process specified data in specified manners, as such data becomes available from upstream within the data pipeline(s). Human users (rather than, or in addition to, the agents 114, 116) may also execute read/write transactions within the technology landscape 105 and using any available and/or authorized data store, including the read data store 104 and the write data store 106. For example, such users may represent any employees, partners, contractors, administrators, interns, students, or any other person(s) with some role within, or with respect to, an organization associated with the technology landscape 105.

During associated data transactions, as referenced above and illustrated by the data lineage visualization 110, data may be filtered, joined, split, augmented, reduced, or otherwise processed. For example, in a simple example, a database of all employees may be read (e.g., by the agent 114 from the read data 112), and a subset of employees in Europe may be extracted and joined with data describing duties of those employees (e.g., by the agent 116), and the combined data may then be written to another database (e.g., by the agent 116 to the write data 115).

In example implementations, data that is read during read transactions may be represented and stored using the data lineage manager 102. Data that is written during write transactions may also be provided to the data lineage manager 102. In this way, the data lineage manager 102 may provide a search and compare function to match a read transaction with a corresponding, later-occurring write transaction, to thereby define a data lineage event (also referred to as a lineage event, a data lineage transaction, or a lineage transaction).

In other words, within a given period of time, many different read and write transactions may occur within the technology landscape 105. Many of the read transactions may each be associated with a subsequent write transaction, as in the example provided above, to provide a data lineage event. On the other hand, a given read transaction may not necessarily be associated with a subsequent write transaction, such as when a user reads data on an ad-hoc basis.

Using described techniques, the data lineage manager 102 is able to track and store read transactions as they occur, and to compare write transactions on a pairwise basis to identify, for each write transaction, any relevant or matching read transaction that occurred earlier in time. In example implementations, read transactions that do not have a subsequent write transaction (e.g., identified within a maximum defined time window) may be discarded as not being part of a data lineage. Other scenarios in which detected read and/or write transactions are discarded, filtered, or otherwise not used in a data lineage are described below. Accordingly, even though a large volume of data transactions may occur within the technology landscape 105, the data lineage manager 105 is configured to determine data lineage events associated with relevant pairs of read/write transactions within the larger volume of data, and to thereby construct corresponding data lineages.

In more detail, the read data store 104 and the write data store 106 may be associated with, or be included in or implemented by, one or more servers, and/or may include or implement a suitable operating system (OS). Stored data (to be read and/or written) may represent, e.g., a table, a document, executable code, a file, or any collection of data. Data may be accessed and/or used locally, e.g., at a local workstation of a user, or may be accessed remotely, over a network, to execute any changes, updates, or other modifications associated with reading/writing data.

In example implementations, as shown in FIG. 1, the read data store 104 may include a kernel space 118 and a user space 120. The kernel space 118 generally refers to a core portion of an OS, e.g., of the read data store (or a relevant server thereof), which governs operations of the read data store 104 with respect to, among other things, access to the read data 104.

The user space 120, in contrast, refers to resources of the read data store 104 (e.g., processing and/or memory resources) that have a short-term or long-term association with individual users, such as the agent 114 and/or an authorized human user. For example, the user space 120 may be allocated and used during the read data operations described herein, and then removed when no longer needed, e.g., to conserve resources of the read data store 104.

Thus, the kernel space 118 may be configured to govern all access requests from all potentially authorized users. Meanwhile, the user space 120 may be particular to the agent 114 or other user, or to a group of relevant automated and/or human users for whom access control is desired.

By maintaining separation between the kernel space 118 and the user space 120, the read data store 104 is capable of continually processing read requests, using resources of the kernel space 118, while the user space 120 is separately and simultaneously used to support operations of the data lineage manager 102. Put another way, described techniques may be implemented to provide desired data access transaction tracking for dynamic data lineage generation, without inhibiting an availability or increasing a latency of the data access transactions, themselves.

In more detail, the read data store 104 may include an interceptor 122 and a duplicator 124. The interceptor 122 may be configured to intercept the read data 112 in conjunction with its reading by the agent 114, and the duplicator 124 may be configured to duplicate the read data 112 to obtain a read data copy 125.

Then, as referenced above, further processing of the read data copy 125 may proceed by the user space 120, without interfering with other operations of the kernel space 118 (e.g., in the context of a relevant data pipeline(s)). Specifically, a tree generator 126 in the user space 120 may include a content extractor 128 configured to extract content from the read data copy 125, while identifying various types of metadata that may also be useful in dynamic data lineage generation, as referenced above and described in more detail, below.

Then, a partition handler 130 may partition the extracted content into multiple partitions, which may then be processed by a tree builder 132 configured to calculate a hash of each partition and of combinations of adjacent partitions, to obtain a hash tree representing the read data 112. As described in more detail, below, the hash tree may be stored within a graph database (graph DB) shown as hash trees database 140 of the data lineage manager 102.

As described in detail, below, the hash tree uniquely represents the read data 112 as a whole, while individual portions (e.g., leaves) of the hash tree uniquely represent corresponding portions of the read data 112, as well. The hash tree may thus be referred to as a read head tree that thus enables matching, including partial matching, of a subsequently generated and corresponding write hash tree for the write data 115, where such matching thus results in a data linage event of a data lineage.

Example techniques for generating the read hash tree and the write hash tree are described below. For example, the tree builder 132 may implement one or more suitable hash functions to input a data partition(s) (and combinations of partitions) from the partition handler 130, and to output a corresponding hash value(s), or hash(es).

Hash functions, in general, may be used to transform a data partition to a hash value (often of fixed size) that is unique or nearly unique to the underlying data partition (at least within the context of the system of FIG. 1) in a reproducible manner. For example, a data partition input to a hash function being used at a first time will result in the same hash value obtained when the same data partition is input to the same hash function at a second, later time, and that hash value is very unlikely to be obtained from any other non-duplicative data partition. Examples of such hash function are well known, and may include, e.g., variations of the Secure Hashing Algorithm (SHA), or more simplified hash functions, such as checksums or cyclic redundancy checks.

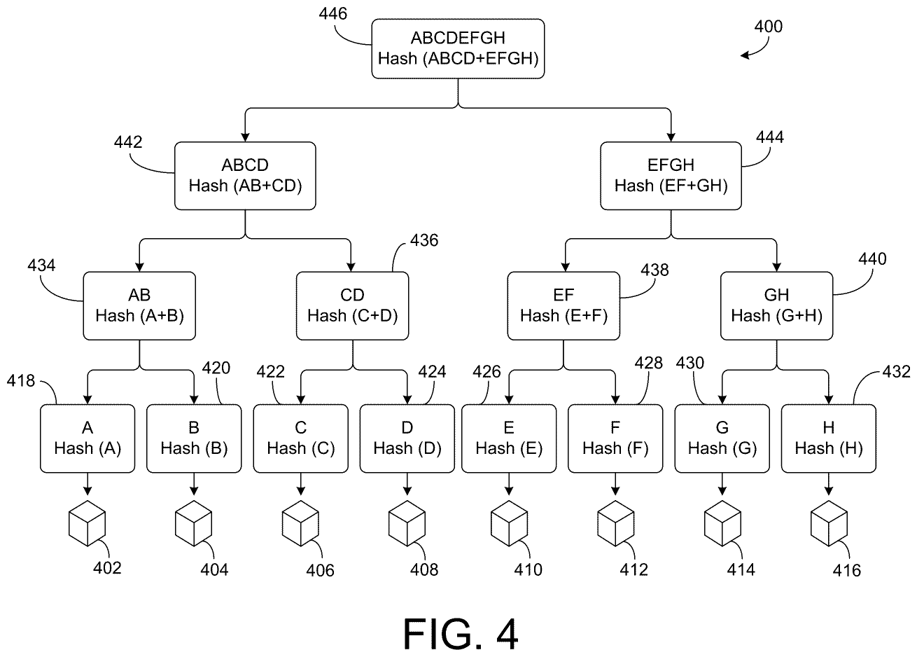

The hash trees of the hash trees graph database 140 may thus include a root, a branch, and/or a leaf structure of hash values of corresponding data partitions. For example, the hash tree 136 may be constructed as a binary hash tree, e.g., a Merkle tree, in which data partitions are individually hashed, and then pairs of data partitions are concatenated and hashed again to obtain another level of the tree, and this process is repeated until an entirety of the dataset (e.g., all of the read data copy 125) is hashed. The hash of the entire data set thus provides a root hash that represents the entire data set. In particular examples described below, such a hash tree is described as a Merkle tree, which is a particular type of binary hash tree suitable for use in the system of FIG. 1. Examples of Merkle trees are illustrated with respect to FIGS. 4-6, for the sake of illustration and explanation. However, other types of hash trees may be used, as well.

The write data store 106 is also illustrated as including a tree generator 135. Although not shown separately in FIG. 1 for the sake of conciseness, the write data store 106 may also include a kernel space and a user space, with the tree generator 135 being included in the user space. In this way, as already described with respect to the kernel space 118 of the read data store 104, an interceptor of the kernel space of the write data store 106 may be configured to intercept the write data 115 for duplication by a duplicator to obtain a write data copy.

Also analogously to operations of the kernel space 118, the kernel space of the write data store 106 may thus proceed to process the write data 115 without increasing an associated latency, while the tree generator 135 within the user space of the write data store 106 separately utilizes the write data copy to generate a write hash tree to be provided to the data lineage manager 102. Although also not shown separately in the example of FIG. 1, the tree generator 135 of the write data store 106 may include one or more modules corresponding to the content extractor 128, the partition handler 130, the tree builder 132, and the policy handler 134 of the tree generator 126.

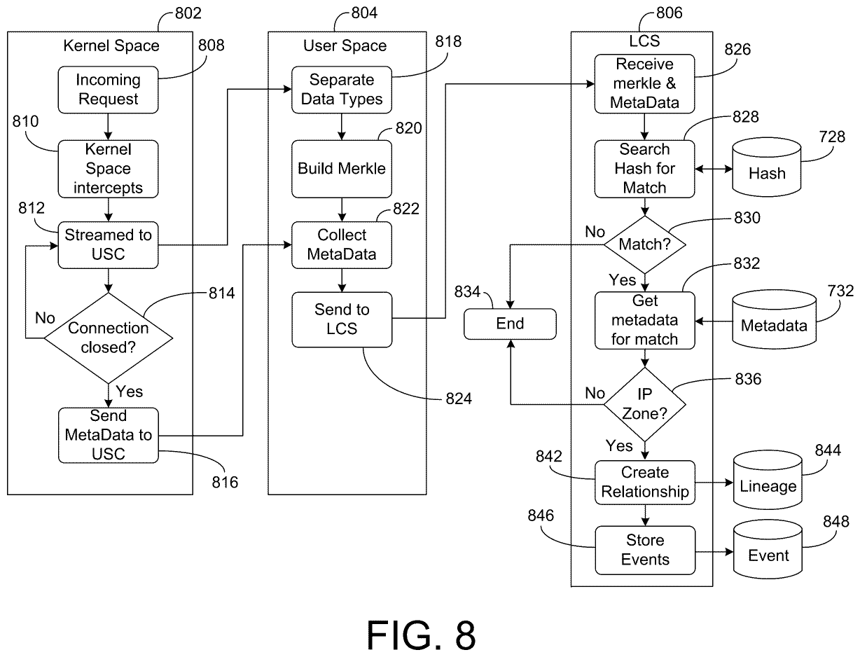

Some differences between operations of the tree generator 135 and the tree generator 126 may exist as a result of differences in nature between write transactions and read transactions. For example, during a write transaction, some metadata may not initially exist, and may be created during or otherwise in conjunction with the write transactions. For example, primary key(s) and other metadata may be assigned during the write transaction. As a result, in some cases, it may be necessary or desirable to query the write data 115 following a completion of the write transaction to ensure that all relevant metadata has been captured, as described in more detail, below, with respect to FIG. 8.

Therefore, the tree generator 135 may generate a write hash tree that uniquely corresponds as a whole to the write data 115 and that includes hash tree portions that uniquely represent corresponding portions of the write data 115. As referenced above, and described in more detail, below, the data linage manager 102 may thus compare the write hash tree generated by the tree generator 135 against previously stored read hash trees within the hash trees graph DB 140, including the read hash tree generated by the tree generator 126 for the read data 112. Accordingly, the data lineage manager 102 may match the write hash tree generated by the tree generator 135 with the read hash tree generated by the tree generator 126 for the read data 112 to thereby identify a data lineage event, even if the write data 115 has been modified from, and is only a partial match for, the read data 112.

In FIG. 1, the lineage data manager 102 is illustrated as including a lineage construction service 136 and lineage data storage 138. The lineage data storage 138 generally provides storage of information kept for later matching, identification, and validation of lineage-specific information, as well as the lineage-specific information itself. As shown, in addition to the hash trees DB 140, the lineage data storage 138 includes a meta data DB 142 storing transaction-related metadata, as well as a lineage events DB 144 and a lineage data DB 145.

The lineage construction service 136 includes an IP zone verifier 146, which, as referenced above, may be configured to reduce required data processing by, e.g., filtering or restricting potential read/write transaction matches (and associated searching operations) based on network address information of the transactions. The IP zone verifier 146 may use network address information obtained using, e.g., the metadata retriever 134 and/or stored using the meta data DB 142.

A comparator 148 may be configured to perform comparisons of hash trees of write data, such as the write data 115, against previously stored hash trees of read data, such as the read data 112. For example, the hash tree of the read data 112 may be stored in the hash trees DB 140 at a time of read operations of the agent 114. Other hash trees associated with other read operations may similarly be stored using the hash trees DB 140. Upon receipt of the hash tree of the write data 115, the comparator 148 may use the hash tree of the write data 115 to execute a search of the hash trees DB 140, perhaps limited by the IP zone verifier, to identify the corresponding hash tree of the read data 112.

A lineage event generator 149 may be configured to then generate a lineage event for storage using the lineage events DB 144. For example, a lineage event may include information related to relevant read/write transactions. The lineage events may be formatted to be easy to search and filter, e.g., to find desired subsets of lineage events and/or to validate specific lineage events.

A lineage generator 150 may be configured to generate lineage data of the lineage data DB 145 in a manner that is formatted for processing by the lineage visualization service 108 to produce the data lineage visualization 110. For example, in some implementations, the lineage events DB 144 may store pairs of read/write transactions, while the lineage data 145 may store relationships reflecting the splitting and/or merging of multiple data sets, as reflected in the data lineage visualization 110. Thus, the lineage generator 150 may generate the lineage data of the lineage data DB 145 in a manner that facilitates data governance, regulation compliance, root case and impact analysis, and other features and advantages of data lineages.

In FIG. 1, the data lineage manager 102 is illustrated as being implemented using at least one computing device 152, including at least one processor 154, and a non-transitory computer-readable storage medium 156. That is, the non-transitory computer-readable storage medium 156 may store instructions that, when executed by the at least one processor 154, cause the at least one computing device 152 to provide the functionalities of the data lineage manager 102 and related functionalities.

Although the at least one computing device 152 is illustrated in FIG. 1 only with respect to the data lineage manager 102, it will be appreciated that the read data store 104 and the write data store 106 will also be implemented using corresponding processing and memory resources to implement the various functionalities and modules illustrated and described with respect to FIG. 1. Moreover, although FIG. 1 illustrates the read data store 104, the data lineage manager 102, and the write data store 106 as three separate devices, it will be appreciated that various ones of the functionalities and modules illustrated in a particular context may be implemented in other contexts as well. For example, the data lineage manager 102 may be implemented on the same physical or virtual hardware as the read data store 104, as long as central access is provided with respect to such hardware.

Moreover, although the system of FIG. 1 has primarily been described with respect to a single, closed technology landscape 105, it will be appreciated that such a technology landscape may nonetheless be extended to include resources available over a public network. For example, such resources may be included as part of a virtual private network (VPN). In other examples, a cloud server that may not be part of (e.g., under control of) an organization providing the technology landscape 105 of FIG. 1 may still be used in the context of FIG. 1. For example, the read data 112 may be stored using a cloud server, but may still be subjected to the same procedures described above, with corresponding modifications to accommodate use of the cloud server.

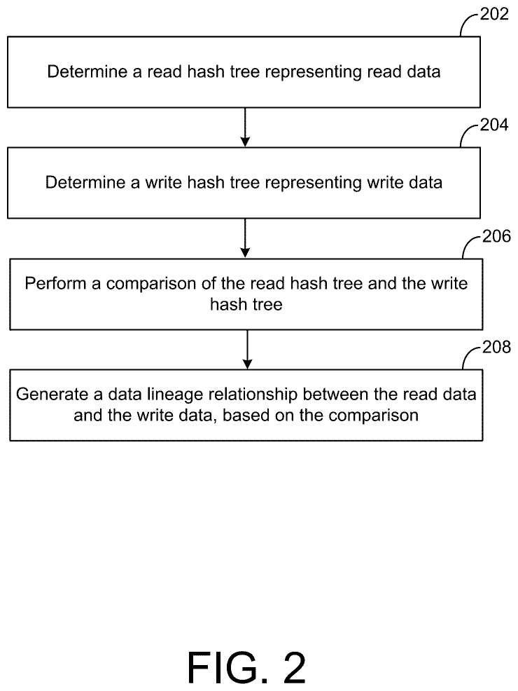

FIG. 2 is a flowchart illustrating example operations of the system of FIG. 1. In the example of FIG. 2, operations 202 to 208 are illustrated as separate, sequential operations. In various implementations, the operations 202 to 208 may include suboperations, may be performed in a different order, may be performed iteratively, may include alternative or additional operations, or may omit one or more operations or suboperations.

In the example of FIG. 2, a read hash tree representing read data may be determined (202). For example, the tree generator 126 may generate a hash tree, e.g., a binary hash tree such as a Merkle tree, using the read data copy 125 of the read data 112. In this way, operations of the agent 114 and any other operations of the read datastore 104 may continue in an uninterrupted manner. In the example of FIG. 1, as described above, the kernel space 118 may be configured to provide the read data copy 125 for use by the tree generator 126 in generating a corresponding hash tree within the user space 120, but other techniques may be used to generate and utilize the read data copy 125, as well.

Although not shown separately in FIG. 2, the hash tree of the read data 112 (e.g., of the read data copy 125) may be generated from content, e.g., transaction data, of the read data set 112, which may be separated from facilitation data and other metadata of the read data 112. The hash tree of the read data 112 and the metadata of the read data 112 may be stored at the central data lineage manager 102, e.g., using the hash trees DB 140 and the metadata DB 142, respectively.

A write hash tree representing write data may be determined (204). For example, the tree generator 135 of the write datastore 106 may generate a hash tree of the write data 115, or, e.g., of a write data copy of the write data 115. As described, the hash tree of the write data may be provided based only on content or transactional data of the write data, while separated metadata of the write data may be maintained separately.

A comparison of the read hash tree and the write hash tree may be performed (206). For example, the comparator 148 may determine the write hash tree upon receipt thereof from the tree generator 135. In other examples, the write hash tree may be stored in the hash trees DB 140. The comparator 148 may determine the read hash tree from the hash trees DB 140 by comparing the write hash tree against available or potentially relevant read hash trees stored in the hash trees DB 140, until a match is found between the write hash tree and the read hash tree. As described, IP zoning information and/or other metadata may be used to facilitate search and compare operations. Specific examples of matching techniques are provided below, but should be understood to include not only identical or nearly identical matches, but also partial matches. For example, portions of the read hash tree and the write hash tree may be compared, and a match may be determined when sufficient portions of the read/write hash trees match one another. For example, a similarity threshold may be set as a percentage or portion of hash tree(s) required to match before determining sufficient similarity between the hash trees.

A data lineage relationship between the read data and the write data may be generated, based on the comparison (208). For example, the lineage generator 150 of FIG. 1 may determine a data lineage relationship between the underlying read/write transactions, based on the similarity threshold being met during the comparison of the read/write hash trees.

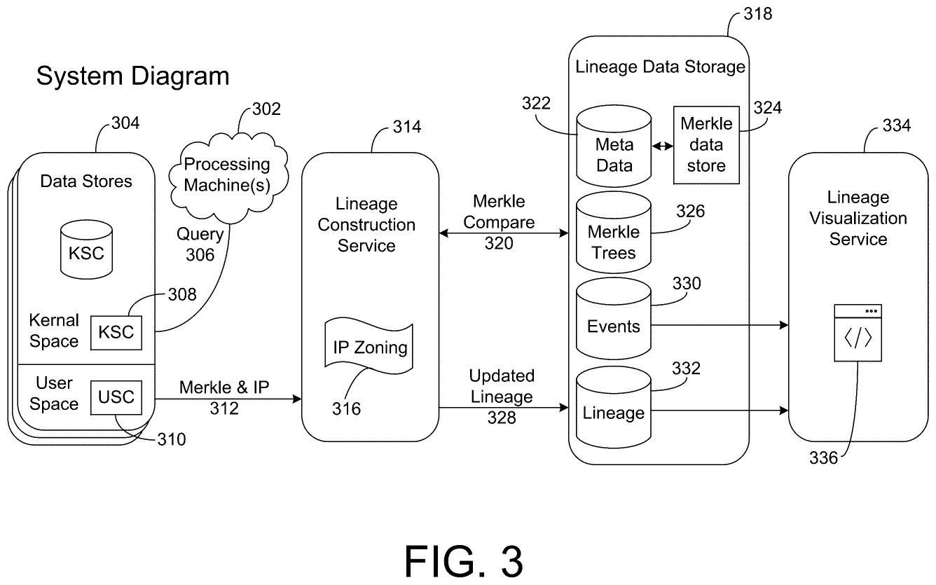

FIG. 3 is a block diagram illustrating an example implementation of the system of FIG. 1. In the example of FIG. 3, a processing machine(s) 302 represents any computing resource(s) facilitating movement and other processing of data. The processing machine 302 may be, e.g., a desktop, a workstation of a person moving data, or an automation endpoint that automates the movement of data. For example, the processing machine 302 may represent an agent-based orchestration solution.

In FIG. 3, data stores 304 represents any physical or virtual data storage device(s), and may receive a query 306 from the processing machine 302. The data stores 304 may be executed on a physical or virtual host. Although shown separately in FIG. 3, one or more of the data stores 304 may be provided using, or may be operated in conjunction with, an instance of the processing machine 302.

Such hosts may be used to implement various OSs and/or storage and/or file systems. For example, a host may be implemented as a Linux system providing an Oracle server, as a Linux system providing an SQL server, as an OSX system providing a network file system (NFS), or as a Windows system providing a file transfer protocol (FTP) data store. Of course, the above examples are non-limiting, and included to illustrate the diversity of contexts in which described techniques may be used.

Further in FIG. 3, the data stores 304 includes a kernel space component (KSC) 308 and a user space component (USC) 310, corresponding generally to the kernel space 118 and the user space 120 FIG. 1. The data stores 304 may implement the KSC 308 as an extended Berkeley Packet Filter (eBPF) component, which is a virtual component within the Linux kernel that allows desired programs to run without requiring modifications of existing kernel source code. In other examples, the data stores 304 may implement a kernel hook as the KSC 308, e.g., as custom code inserted into the kernel to alter or extend the kernel's behavior without modifying the original kernel code.

By way of more specific example, the KSC 308 may be understood to utilize Linux eBPF events implemented by eBPF logic that may be broken down into logic running in two different segmented portions of the Linux operating system. The USC 310 may run on the operating system with user-space privileges, and may be responsible for, e.g., deploying the KSC 308 at startup and collecting data passed off by the KSC 308, as well as the various functions described above with respect to FIG. 1.

More generally, the KSC 308 may generally represent any component running on the OS with kernel space privileges. The KSC 308 may be configured to intercept read data 112 or write data 115 and forward it to the USC 310, as described above.

A lineage construction service (LCS) 314 represents an example of the lineage construction service 136 of FIG. 1. As described with respect to FIG. 1, the lineage construction service 314 may be configured to receive information 312 from the USC 310 that includes a Merkle tree (as an example of the hash tree representations of read/write data of FIG. 1) used for read/write data comparisons and associated IP zoning metadata to be analyzed by an IP zoning component 316 that facilitates the read/write data comparisons. Accordingly, the lineage construction service 314 may be configured to generate data lineage (including determining directionality of data movements) and publish lineage creation events.

Further in FIG. 3, lineage data storage 318 provides a centralized data store that supports operations of the lineage construction service 314. For example, the lineage construction service 314 may execute a Merkle compare operation 320 using metadata 322, Merkle data store 324, and Merkle trees 326. For example, storage of the Merkle trees 326 may be implemented using a graph DB optimized for storing calculated hashes of hash trees as well as links between the hashes. The metadata 322 may include information tracking a source (e.g., each read/write data store) of each Merkle tree as tracked using the Merkle data store 324, as well as other metadata, such as IP zoning metadata.

Accordingly, the lineage construction service 314 may provide an updated lineage 328 for each matched Merkle tree and underlying read/write transactions, which may be stored in a lineage DB 332. The lineage DB 332 may be implemented as a graph DB that links source and target datasets with lineage relationships, based on processing performed by the lineage constructions service 314.

Events DB 330 may be configured to store lineage creation events published by the lineage constructions service 314. The events EB 330 allows for filtering lineage events on time, source, and destination, as well as navigating to the lineage in the lineage DB using a relationshipID. An example lineage creation event is shown below in pseudocode 1:

Pseudocode 1

```
Lineage Creation Event:
  {
    Source: Datastore Identifier,
    Destination: Datastore Identifier,
    Timestamp: timestamp recorded during write of data, passed in metadata sent to
LCS,
    RelationshipID: A unique identifier provided by the Lineage DB that points to the
                  relationship and is utilized to navigate directly to the relationship
                  and view related entities in a data lineage visualization
  }
```

A lineage visualization service 334 may be configured to provide a user interface 336 to visually display determined data lineages. The lineage visualization service 334 may also be used to create and manage existing policies associated with datasets in the various datastores of the lineage data storage 318. The lineage visualization service 334 may also be used to notify users of new unidentified datasets that need attention.

FIG. 4 is an example hash tree 400 used in the systems of FIGS. 1-3. FIG. 4 illustrates example data partition 402, example data partition 404, example data partition 406, example data partition 408, example data partition 410, example data partition 412, example data partition 414, and example data partition 416. In FIG. 4, the above-referenced data partitions are also referenced as data partitions A, B, C, D, E, F, G, and H, so that combinations or concatenations of such data partitions may be easily referenced as, e.g., A+B, C+D, AB+CD, E+F, G+H, EF+GH, or ABCD+EFGH.

The above-referenced data partitions illustrated in FIG. 4 may thus be understood to represent results of operations of the partition handler 130 of FIG. 1. For example, as described with respect to FIG. 1, the partition handler 130 may input the accessed data copy 125 and output equal-sized partitions of data. A size of each partition may be preset to a desired value, such as, e.g., 1K, 2K, 4K, 8K, or 16K bytes of data.

Partition size thus represents a configurable parameter that may be set and updated as needed by an administrator or designer of the tree generator 126 and the tree generator 135 of FIG. 1. In general, smaller partition sizes require more data processing during subsequent attempts to compare and match different hash trees, but provide more opportunities for successful matching (e.g., more granular data matching), while larger partition sizes require less data processing during subsequent attempts to compare and different hash trees, but provide fewer opportunities for successful matching (e.g., less granular data matching).

As further illustrated in FIG. 4, operations of the tree builder 132 of FIG. 1 may proceed with calculating a hash value for each of the data partitions 402, 404, 406, 408, 410, 412, 414, 416. That is, a hash value 418 is calculated for the data partition 402, a hash value 420 is calculated for the data partition 404, a hash value 422 is calculated for the data partition 406, a hash value 424 is calculated for the data partition 408, a hash value 426 is calculated for the data partition 410, a hash value 428 is calculated for the data partition 412, a hash value 430 is calculated for the data partition 414, and a hash value 432 is calculated for the data partition 416.

Then, a hash value is generated for each pair of the calculated hash values, e.g., for each concatenated pair of underlying data partitions. As shown, a hash value 434 is calculated for a concatenation of data partitions 402, 404 of hash values 418, 420, a hash value 436 is calculated for a concatenation of data partitions 406, 408 of hash values 422, 424, a hash value 438 is calculated for a concatenation of data partitions 410, 412 of hash values 426, 428, and a hash value 440 is calculated for a concatenation of data partitions 414, 416 of hash values 430, 432.

Similarly, a hash value 442 is calculated for a concatenation of data partitions AB+CD (i.e., for data partitions 402, 404, 406, 408), and a hash value 444 is calculated for a concatenation of data partitions EF+GH (i.e., for data partitions 410, 412, 416, 418). Finally in FIG. 4, a hash value 446 is calculated for a concatenation of data partitions ABCD+EFGH (i.e., for all data partitions 402, 404, 406, 408, 410, 412, 414, 416). As described in detail, below, the final hash value 446 thus represents a root of the hash tree 400 of FIG. 4 and may be used to link the hash tree of FIG. 4 (and thus an entirety of the corresponding data), to a relevant access policy.

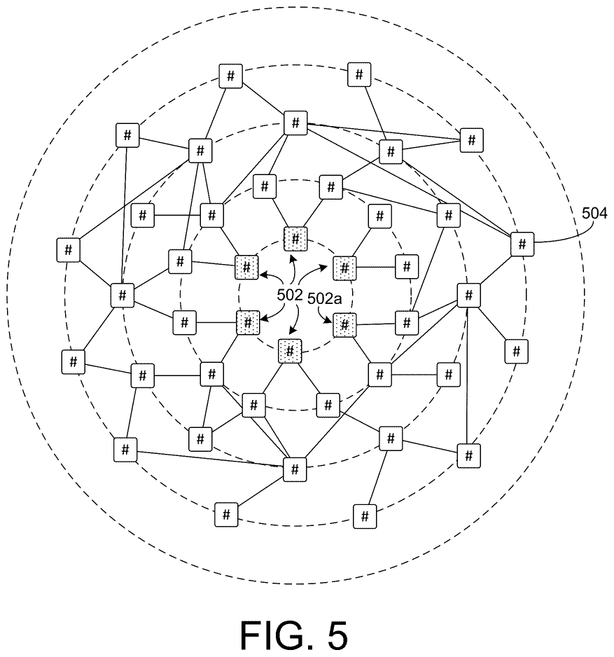

FIG. 5 illustrates use of a graph database of FIGS. 1-3 to store multiple hash trees. FIG. 5 also illustrates efficiencies that may be gained in storing and comparing hash trees for dynamic data lineage generation, as described herein.

In FIG. 5, a plurality of nodes 502 represent root nodes of corresponding hash trees. For example, a root node 502a may correspond to the root hash, node 446, of FIG. 4. Thus, each of the concentric circles/layers of FIG. 5 represents a corresponding level of the hash tree of FIG. 4. For example, an outermost or leaf node 504 may correspond to one of the originally computed hash values 418, 420, 422, 424, 426, 428, 430, 432 of FIG. 4.

FIG. 5 further illustrates that duplications and/or redundancies may exist within calculated hash values of the various graph nodes (i.e., entities corresponding to hash values). A number or frequency of such duplications and/or redundancies may depend on various factors, such as a nature and content of underlying data sets, a type of hashing algorithm being used, and/or a size of data partitions being used.

For example, some data sets, by their nature or virtue of their intended use, may include duplicative data. Further, when relatively small data partitions are used, a number of possible combinations of underlying bit values is reduced, so that, for large quantities of data, it becomes relatively more likely that duplicated hash values and duplicated concatenated hash values may occur.

Obtaining such redundancies in the extreme (e.g., selecting extremely small partition sizes) may lead to excessive numbers of required calculations to obtain overly duplicative hash trees. On the other hand, a presence of such redundancies in a more limited quantity may result in more efficient graph storage and faster comparisons when comparing pairs of hash trees. Put another way, described techniques provide various trade-offs and design choices between partition size, granularity of potential data matches, number of computations required, speed of hash tree comparisons, and quantity of memory required for graph storage, among other factors.

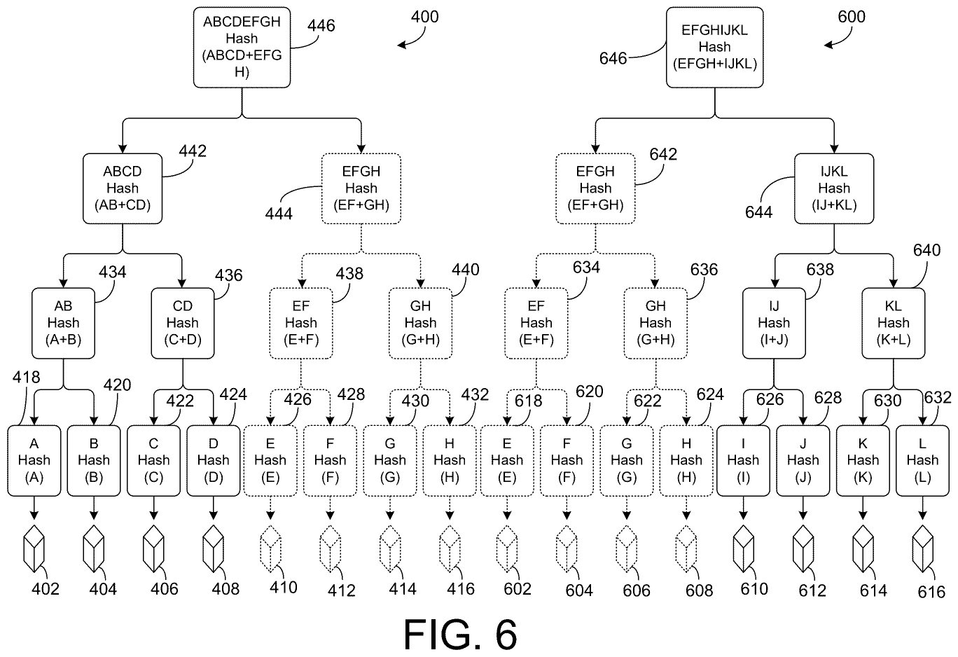

FIG. 6 illustrates an example comparison of multiple hash trees of FIGS. 4 and 5. That is, FIG. 6 illustrates a comparison of the hash tree 400 of FIG. 4 with a hash tree 600, both of which may be stored using the techniques described with respect to FIG. 5.

In FIG. 6, the hash tree 400 may represent a hash tree constructed for the read data copy 125 of FIG. 1, while the hash tree 600 may represent a hash tree constructed for a write data copy of the write data 115 of FIG. 1.

FIG. 6 illustrates example data partition 602, example data partition 604, example data partition 606, example data partition 608, example data partition 610, example data partition 612, example data partition 614, and example data partition 616. As in FIG. 4, the above-referenced data partitions are also referenced as data partitions E, F, G, H, I, J, K, and L, so that combinations or concatenations of such data partitions may be easily referenced as, e.g., E+F, EF+GH, or I+J, K+L, IJ+KL, or EFGH+IJKL.

As further illustrated, and as already described with respect to FIG. 4, hash value 618 may be determined from partition 602, hash value 620 may be determined from partition 604, hash value 622 may be determined from partition 606, hash value 624 may be determined from partition 608, hash value 626 may be determined from partition 610, hash value 628 may be determined from partition 612, hash value 630 may be determined from partition 614, and hash value 632 may be determined from partition 616.

Then, hash values 634, 636, 638, 640, 642, 644, and 646 may be calculated for underlying pairs of data partitions or concatenated data partitions, as shown and as previously explained for FIG. 4. Root hash value 646 of the hash tree 600 thus corresponds to one of the root nodes 502 of FIG. 5, similarly to the root node 446 of the hash tree 400.

In FIG. 6, dashed lines are used to indicate matches between corresponding partitions and hash values that may be determined when comparing the hash trees 400, 600. As shown, hash value 426 for data partition 410, hash value 428 for data partition 412, hash value 430 for data partition 414, and hash value 432 for data partition 416 of the hash tree 400 are determined to correspond to hash value 618 for data partition 602, hash value 620 for data partition 604, hash value 622 for data partition 606, and hash value 624 for data partition 608 of the hash tree 600. Similarly, hash value 438 and hash value 440 are determined to correspond to hash value 634 and hash value 636, and hash value 444 is determined to correspond to hash value 642.

FIG. 6 thus illustrates an example in which a certain portion, degree, percentage, or extent of the hash trees 400, 600 match one another. In the example, of two sets of eight data partitions ABCDEFGH and EFGHIJKL, four or 50% of the data partitions are determined to correspond (i.e., EFGH), based on the matching of hash values 444 and 644, and of underlying hash values within the hash trees 400, 600.

Of course, any extent of matching may occur during an actual comparison, ranging from a failure to match any partition or hash value to matching root nodes 446, 646 (which would indicate a match of the entireties of the underlying datasets). As described herein, the degree or extent of such matching may be used to determine whether a write transaction should be related or linked to an earlier read transaction. For example, a similarity threshold based on the degree or extent of such matching may be defined, thereby enabling partial data matches of read/write transactions.

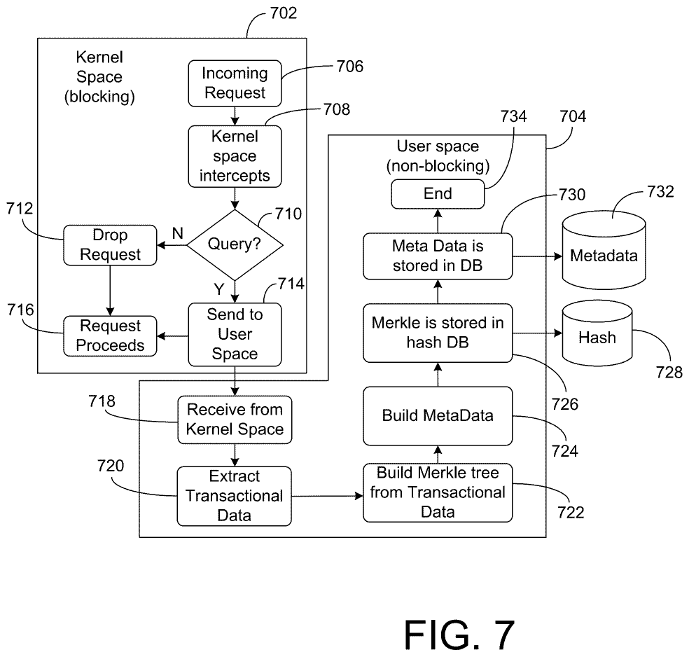

FIG. 7 is a flowchart illustrating example techniques for processing read requests using the techniques of FIGS. 1-6. In the examples of FIG. 7, within a kernel space 702, an incoming request requests information from a datastore (706), marking the beginning of a read transaction. A KSC intercepts the transaction (708). Within the request or transaction, if a query is identified (710), all data provided to satisfy the query is forwarded to a user space 704 (714), whereupon the request proceeds within the KSC 702 (716). If no queries are included (710), then the request may be dropped for purposes of data lineage generation (712), and the request may proceed within the KSC 702. Thus, in either scenario, the original process may proceed in a non-blocking state. In some implementations, forwarding to the user space (714) may occur once an original request connection is closed, when a relevant datastore signals the end of requested data being reached, and/or when a complete message is sent.

Within the user space 704, data is received from the kernel space 702 (718), and transactional data (e.g., content or information) may be extracted and separated from remaining meta data (e.g., facilitation data) (720). In specific examples, in the context of a SQL DB, a connection may be established, authentication information provided, and information regarding relevant DB(s) and included tables (possibly including specific DB fields) may be specified. All such data, and various other types of data, as well, may be supplemental to, or separate from, the actual content of data to be read, and may be stored as metadata.

Within the user space (704), the extracted transactional data may be used to construct a corresponding Merkle tree (722). For example, a Merkle tree may be constructed using the transactional data in a native order of the relevant datastore (e.g., row-based, column-based, or unstructured). For structured data, a Merkle tree in each of a plurality of ordering formats may be constructed, as well.

Corresponding metadata may also be constructed (724), e.g., by parsing the facilitation data. As described above, the metadata may help to identify and characterize the information of the constructed Merkle tree. For example, a remote IP address may be included. Other examples of included metadata may include: (for relational DBs) database ID, table ID, or a list of primary keys in a relational database; (for a network file system (NF S)) NFS store ID, a list of paths, seek pointers; (for NoSQL) databaseID or key paths. The constructed Merkle tree may be stored in its corresponding storage/graph DB (726), e.g., hash DB 728, while the metadata may be stored in a separate DB (730), e.g., metadata DB 732. The metadata DB 732 may also be used to store a root hash of a corresponding Merkle tree.

FIG. 8 is a flowchart illustrating example techniques for processing write requests and generating data lineages using the techniques of FIGS. 1-6. FIG. 8 illustrates a kernel space 802, a user space 804, and a lineage construction service (806).

Within the kernel space 802, a request that involves writing information into a datastore is received (808). In conjunction with opening of a connection and associated write operations marking a beginning of the write transaction, the kernel space intercepts the request (810).

The kernel space 802 notifies the user space 804 and available data is streamed to the user space (804) until the connection is closed (814). For example, a remote entity may signal an end of data has been reached and/or a success notification may be provided by the relevant datastore. Once the connection is closed (814), remaining metadata may be sent to the user space 804 (816). That is, as noted above, at least some metadata may not be available for a write transaction until the transaction is completed.

At the user space 804, received data may be separated into transactional data (e.g., content/information) and facilitation data (818). The user space constructs a corresponding Merkle tree using data stored in a native order of the data store, as also referenced above with respect to FIG. 7. As also referenced with respect to FIG. 7, additional Merkle trees in different DB structures/ordering may be constructed as well.

Additional metadata may be collected (822). As described, the metadata may identify a source of the relevant information (e.g., where the information was stored within the data store). Additionally, or alternatively, a query may be dynamically constructed to run locally to determine relevant metadata. Metadata may include the various types of metadata discussed with respect to FIG. 7, including, e.g., remote IP address, as well as DB information related to any of a relational DB, NFS, or NoSQL DB.

The constructed Merkle tree(s) and the metadata may then be sent to the LCS 806. That is, as described above, a Merkle tree and metadata may be received directly at the LCS 806 (826), as compared to being stored in an intermediate database at this stage.

The LCS 806 may then commence search and compare operations to attempt to match the write transaction to an earlier read transaction, including performing hash-based searches (828) of the hash DB 728 of FIG. 7. More detailed examples of search/match operations for the hash DB 728 are described below.

If no matches are found (830), the process ends (834). For each determined match (830) metadata for the matched hash (e.g., Merkle tree and corresponding read data) may be obtained from the metadata DB 732 (832).

To perform the search and compare operations, a request tree may be traversed in breadth first fashion and put into a stack along with level demarcations. An empty proceed set and an interim result set may be created.

Then, while the stack is not empty, hashes in a previous level may be cleared from the proceed set if its parent is in the current level. Remaining hashes may be transferred from the proceed set in the previous level to the interim result set by level.

A pop stack process may be performed for each level until the level is complete (where hashes of the first set of pops may be put into the proceed set). If a proceed step for a current level is empty, then a search (perhaps in parallel) may be performed for each popped hash in the hash DB 728 that is in the proceed set. For hashes found in the hash DB 728 using this technique, corresponding hash relationships may be compared against the request Merkle tree. That is, if that Merkle tree has the same children (or at least one child) node(s), then the corresponding hash may be put into the proceed set for the next level.

Levels to be processed in an interim result set may be determined based on predetermined threshold levels. For example, an administrator may set a threshold as a minimum number of levels that need to be matched, from the bottom up of a Merkle tree(s), to declare a match.

For qualifying hashes, corresponding roots in the hash DB 728 may be determined. Then, found roots may be collected and returned in order from highest qualified (most similar) level to lowest qualified (least similar) level.

From the obtained metadata for matching Merkle trees, each Merkle tree may be evaluated based on its IP zone relative to the IP zone of the Merkle tree (and associated write transaction data) being compared (836). If no IP zones are related, the process may end (834).

Otherwise, for each related IP zone, a relationship may be created between the corresponding Merkle tree and the Merkle tree of the write transaction data being compared (842). The created relationship may be stored in a lineage DB 844.

For example, entities may be constructed and related using contains/contained relationships, using the metadata, and in a top down order. For example, if the metadata indicates relevant information was stored in a NoSQL database, then the relationship may be constructed as a databaseID->List of Keypaths, in which the arrow represents a ‘contains’ relationship, and for which a reverse contained relationship may also be applied. This relationship may be stored in the graph database shown as the lineage DB 844 in FIG. 8. A reference to each leaf entity in these relationships, e.g., a list of keypaths, may be saved.

For each (sufficiently) matching pair of Merkle trees, example IP zone evaluations may be performed as follows. For example, if both IP addresses are in a whitelist of IP addresses, a lineage relationship may be created. If the write data is not in the whitelist, the lineage relationship may be created. If the read data is not in the whitelist, but the write data is in the whitelist, the lineage relationship may not be created. The preceding rules are merely for example, and other uses of IP zoning to govern lineage relationship creation may be used, as well.

Accordingly, a relationship may be generated, e.g., between an entity representing a list of primary keys and a list of keypaths. An associated timestamp may be included, representing a time of data write as obtained from the metadata accompanying the write transaction.

Finally in FIG. 8, a corresponding event may be generated and stored (846), e.g., in an lineage event DB 848. An example event is represented in Pseudocode 2:

{
Source: Datastore Identifier (DatbaseID of NoSQL for example),
Destination: Datastore Identifier (DatbaseID for RDBMS),
Timestamp: timestamp recorded during write of data, passed in metadata sent to
LCS,
RelationshipType: Concrete/Soft,
RelationshipID: A unique identifier provided by the graph db that can point to the
relationship. This is utilized to navigate directly to the relationship and view related
entities in a visualization
}

Thus, described techniques enable comparison of Merkle trees and related metadata for read/write transactions to build a data lineage graph, even when the data being compared is stored in different information ordering formats. Time series read/write events from kernel space components may be used to identify directionality in the data lineage. IP zoning may be used to restrict generated relationships to those that are most likely to be impactful when generating the data lineage. Hierarchical metadata may be used that enables lineage generation using highly granular data.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatuses, e.g., a programmable processor, a computer, a server, multiple computers or servers, mainframe computer(s), or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

1. A computer program product, the computer program product being tangibly embodied on a non-transitory computer-readable storage medium and comprising instructions that, when executed by at least one computing device, are configured to cause the at least one computing device to:
make a copy of read data in conjunction with a read transaction of a read datastore;
determine a read hash tree representing the read data from the copy of the read data while the read transaction proceeds in a non-blocking state;
determine a write hash tree representing write data;
perform a comparison of the read hash tree and the write hash tree; and
generate a data lineage relationship between the read data and the write data, based on the comparison.

2. (canceled)

3. The computer program product of claim 1, wherein the instructions, when executed, are further configured to cause the at least one computing device to:
make the copy of the read data in a kernel space of the read datastore;
provide the copy of the read data to a user space of the read datastore; and
generate the read hash tree from the copy of the read data within the user space of the read datastore.

4. The computer program product of claim 1, wherein the instructions, when executed, are further configured to cause the at least one computing device to:
make a copy of the write data in conjunction with a write transaction of a write datastore; and
generate the write hash tree from the copy of the write data.

5. The computer program product of claim 1, wherein the instructions, when executed, are further configured to cause the at least one computing device to:
store the read hash tree in a graph database; and
search the graph database using the write hash tree to determine a match between the write hash tree and the read hash tree.

6. The computer program product of claim 5, wherein the instructions, when executed, are further configured to cause the at least one computing device to:
determine the match based on matching portions of the write hash tree and the read hash tree exceeding a threshold.

7. The computer program product of claim 1, wherein the instructions, when executed, are further configured to cause the at least one computing device to:
generate the read hash tree as a read Merkle tree; and
generate the write hash tree as a write Merkle tree.

8. The computer program product of claim 1, wherein the instructions, when executed, are further configured to cause the at least one computing device to:
separate the read data from read metadata associated with a read transaction;
store the read metadata in conjunction with the read hash tree; and
generate the data lineage relationship based on the read metadata.

9. The computer program product of claim 8, wherein the instructions, when executed, are further configured to cause the at least one computing device to:
determine, from the read metadata, a network address of a read datastore storing the read data; and
generate the data lineage relationship based on the network address of the read datastore and on a network address of a write datastore storing the write data.

10. The computer program product of claim 1, wherein the instructions, when executed, are further configured to cause the at least one computing device to:
partition the copy of the read data into a plurality of partitions;
generate hash values from the plurality of partitions; and
generate the read hash tree using the hash values.

11. A computer-implemented method, the method comprising:
making a copy of read data in conjunction with a read transaction of a read datastore;
determining a read hash tree representing the read data from the copy of the read data while the read transaction proceeds in a non-blocking state;
determining a write hash tree representing write data;
performing a comparison of the read hash tree and the write hash tree; and
generating a data lineage relationship between the read data and the write data, based on the comparison.

12. The method of claim 11, further comprising:
storing the read hash tree in a graph database; and
searching the graph database using the write hash tree to determine a match between the write hash tree and the read hash tree.

13. The method of claim 11, further comprising:
determining the match based on matching portions of the write hash tree and the read hash tree exceeding a threshold.

14. The method of claim 11, further comprising:
generating the read hash tree as a read Merkle tree; and
generating the write hash tree as a write Merkle tree.

15. The method of claim 11, further comprising:
separating the read data from read metadata associated with a read transaction;
storing the read metadata in conjunction with the read hash tree; and
generating the data lineage relationship based on the read metadata.

16. A system comprising:
at least one memory including instructions; and
at least one processor that is operably coupled to the at least one memory and that is arranged and configured to execute instructions that, when executed, cause the at least one processor to:
make a copy of read data in conjunction with a read transaction of a read datastore;
determine a read hash tree representing the read data from the copy of the read data while the read transaction proceeds in a non-blocking state;
determine a write hash tree representing write data;
perform a comparison of the read hash tree and the write hash tree; and
generate a data lineage relationship between the read data and the write data, based on the comparison.

17. The system of claim 16, wherein the instructions, when executed, are further configured to cause the at least one processor to:
store the read hash tree in a graph database; and
search the graph database using the write hash tree to determine a match between the write hash tree and the read hash tree.

18. The system of claim 16, wherein the instructions, when executed, are further configured to cause the at least one processor to:
determine the match based on matching portions of the write hash tree and the read hash tree exceeding a threshold.

19. The system of claim 16, wherein the instructions, when executed, are further configured to cause the at least one processor to:
generate the read hash tree as a read Merkle tree; and
generate the write hash tree as a write Merkle tree.

20. The system of claim 16, wherein the instructions, when executed, are further configured to cause the at least one processor to:
separate the read data from read metadata associated with a read transaction;
store the read metadata in conjunction with the read hash tree; and
generate the data lineage relationship based on the read metadata.
